(19) United States
(12) Patent Application Publication
(10) Pub. No.: US 2023/0308287 A1
(43) Pub. Date: Sep. 28, 2023

(54) THRESHOLD SIGNATURES

(71) Applicant: nChain Licensing AG, Zug (CH)

(72) Inventors: Michaella PETTIT, London (GB); Craig Steven WRIGHT, London (GB); Alexander MACKAY, London (GB)

(21) Appl. No.: 18/020,861

(22) PCT Filed: Jul. 19, 2021
(86) PCT No.: PCT/EP2021/070124

§ 371 Date: Feb. 10, 2023

(30) Foreign Application Priority Data
Aug. 18, 2020 (GB) 2012874.0

(51) Int. Cl. H04L 9/32; H04L 9/30; H04L 9/08

(52) U.S. Cl. CPC H04L 9/3247; H04L 9/30; H04L 9/088

(57) ABSTRACT

A computer-implemented method of generating a share of a digital signature, wherein each participant has a respective share of a first shared private key, wherein the method is performed by a first participant and comprises: obtaining a first message; generating a first data item based on at least a hash of a first external data item; generating a first ephemeral private key share of an ephemeral private key based on the first data item and a respective data item generated by each other participant; generating an ephemeral public key corresponding to the ephemeral private key; generating a first signature share based on the first message, the first ephemeral private key share, a first share of the first shared private key, and the ephemeral public key; and making the first signature share available to a coordinator for generating a first signature based on at least a threshold number of signature shares.

### CROSS REFERENCE TO RELATED APPLICATIONS

This application is the U.S. National Stage of International Application No. PCT/EP2021/070124 filed on Jul. 19, 2021, which claims the benefit of United Kingdom Patent Application No. 2012874.0, filed on Aug. 18, 2020, the contents of which are incorporated herein by reference in their entireties.

### TECHNICAL FIELD

The present disclosure relates to a method of generating a share of a digital signature. In particular, the method enables external data to be embedded within a share of a digital signature.

### BACKGROUND

In general, a shared secret may be used to share a data item that is distributed amongst a group of participants. Each participant has a different share of the secret. Normally, the secret can only be reconstructed when a certain number (referred to as the “threshold”) of participants make their respective shares available, e.g. to be combined together to calculate the secret.

Public-key cryptography is a type of cryptographic system that uses pairs of keys: private keys which are known only to the owner of the private key, and public keys which are generated based on the corresponding private key and which may be disseminated without compromising the security of the private key.

Public-key cryptography enables a sender to encrypt a message using a recipient's public key (i.e. the public key corresponding to a private key known only to the recipient). The encrypted message can then only be decrypted using the recipient's private key.

Similarly, a sender can use their own private key to sign a message, e.g. to prove that the message is being sent by the sender, and/or to indicate that the sender agrees with the message. The signer (i.e. the party generating the signature) uses their private key to create a digital signature based on the message. Creating a digital signature based on a message means supplying the message and private key to a function that generate the signature based on both the message and private key. The signature is added to (e.g. tagged onto) the message or otherwise associated with the message. Anyone with the signer's corresponding public key can use the same message and the digital signature on the message to verify whether the signature was validly created, i.e. whether the signature was indeed made using the signer's private key. As well as ensuring the authenticity of a message, digital signatures also ensure the integrity and non-repudiation of the message. That is, a digital signature can be used to prove that a message has not been changed since it was signed with the signature, and that the creator of a signature cannot deny in the future that they created the signature.

A digital signature scheme typically involves three procedures, i.e. algorithms. A key generation algorithm is used to generate a random private key and a corresponding public key. A signing algorithm is used to generate a signature based on a message and the private key. A verification algorithm is used to verify, given a public key and the message, whether the signature has been generated using the corresponding private key and according to the signing algorithm.

A common use of a shared secret is as a shared private key of a private-public key pair. That is, the private key may be distributed amongst a group of participants such that no single participant has access to the private key. Therefore no single participant can generate a valid signature of a message. Instead, some or all of the participants must together generate the private key in order for the signature to be generated.

Instead of the participants sharing their private key shares in order to generate a signature, they may instead use a threshold signature scheme. A threshold signature scheme allows a threshold number of participants in a group to create a digital signature based on a message using individual shares of a shares private key, without the private key being made available to any one participant. Here, a digital signature is a signature which is generated based on the message to be signed. In such a scheme, the signature can only be created if the threshold number of participants agree to generate the signature on the message. Any attempt to generate a signature using a smaller number of participants will not generate a valid signature. Therefore, a valid signature by the group (i.e. one generated using the message and the shared private key) provably had the threshold number of people agree to generate the signature. This also implies that any adversary needs to obtain the threshold number of shares of the private key to forge a signature with that private key.

### SUMMARY

As mentioned above, a shared secret may be a shared private key, with each of a group of participants having a respective share of the shared private key. A threshold number of participants may together generate a valid signature using the shared private key without actually generating the shared private key. The public key may be made available to a third party to validate the signature, i.e. to verify that at least the threshold number of participants agreed to generate the signature. In these cases it would be desirable for a participant to be able to prove that they contributed to generating the signature.

According to one aspect disclosed herein, there is provided a computer-implemented method of generating a share of a digital signature, wherein each participant of a group of participants has a respective share of a first shared private key, and wherein the method is performed by a first participant of the group and comprises: obtaining a first message; generating a first data item based on at least a hash of a first external data item; generating a first ephemeral private key share of an ephemeral private key, wherein the first ephemeral private key share is generated based on the first data item and a respective data item generated by each other participant; generating an ephemeral public key corresponding to the ephemeral private key; generating a first signature share based on the first message, the first ephemeral private key share, a first share of the first shared private key, and the ephemeral public key; and making the first signature share available to a coordinator for generating a first signature based on at least a threshold number of respective signature shares.

According to another aspect disclosed herein, there is provided a computer-implemented method of verifying that a digital signature has been partly generated by a first participant, wherein the method is performed by a verifying party and comprises: obtaining a first signature comprising first and second signature components; obtaining a candidate first external data item from the first participant, and one or more respective public key corresponding to a respective data items, one for each other participant; generating a candidate public key based on a hash of the candidate first external data item; generating a candidate ephemeral public key based on the candidate public key and the obtained one or more public keys; generating a candidate first signature component based on the candidate ephemeral public key; and verifying that the first signature has been partly generated by the first participant based on whether the candidate first signature component corresponds to the first signature component.

The first participant generates a share of digital signature for signing a message. In the context of the blockchain, the message may be a transaction, e.g. the signature may be included in an input of a transaction for unlocking an output of a previous transaction. In general the message may be any form of message, e.g. a document, and does not necessarily need to be related to the blockchain. The signature share is generated at least in part based on an ephemeral private key share, e.g. a share of a one-time use private key. The ephemeral private key share is generated at least in part based on external information, i.e. the “external data item”. The external data item may comprise and/or be generated based on an identifier of the first participant, e.g. a name, address, phone number, national insurance number, passport number, public key, etc. In some examples the external data item is a digital signature generated by the first participant. The first participant makes the signature share available to a coordinator for generating, along with enough other signature shares, a complete signature. The coordinator may in some examples be the first participant.

Once generated, the signature can be verified using a public key corresponding to the shared private key. However, that does not enable the first participant to prove to a verifying party that the first participant generated a share of the signature. Rather, since only the first participant knows the external data item used to generate the signature share, the first participant can reveal the external data item and enable the verifying party to reconstruct at least part (i.e. the “first signature component”) of the signature. That is, the verifying party generates a candidate first signature component based on the external data item. If the reconstructed first signature component (i.e. the candidate first signature component) matches the first signature component, then the verifying party can be sure that the first participant did indeed contribute to the signature.

The present invention enables external information to be incorporated into, i.e. embedded within, a signature. The external information is not known by a verifying party unless it is provided by the first participant. Specifically, the external information is used to derive the signature. For instance, the first participant may embed a public key that is linked to the first participant's identity into a signature that is created using a different private key (i.e. the shared private key that does not correspond to the embedded public key). This allows the first participant to prove that they have generated a share of the signature.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of an example system for implementing embodiments of the present invention,

FIG. 5 is a flow chart showing an example method for generating a digital signature share according to some embodiments of the present invention,

FIG. 6 is a flow chart showing an example method for verifying that a party has generated a digital signature share according to some embodiments of the present invention, and

FIG. 7 shows an example Merkle tree generated according to some embodiments of the present invention.

### DETAILED DESCRIPTION OF EMBODIMENTS

### Example System Overview

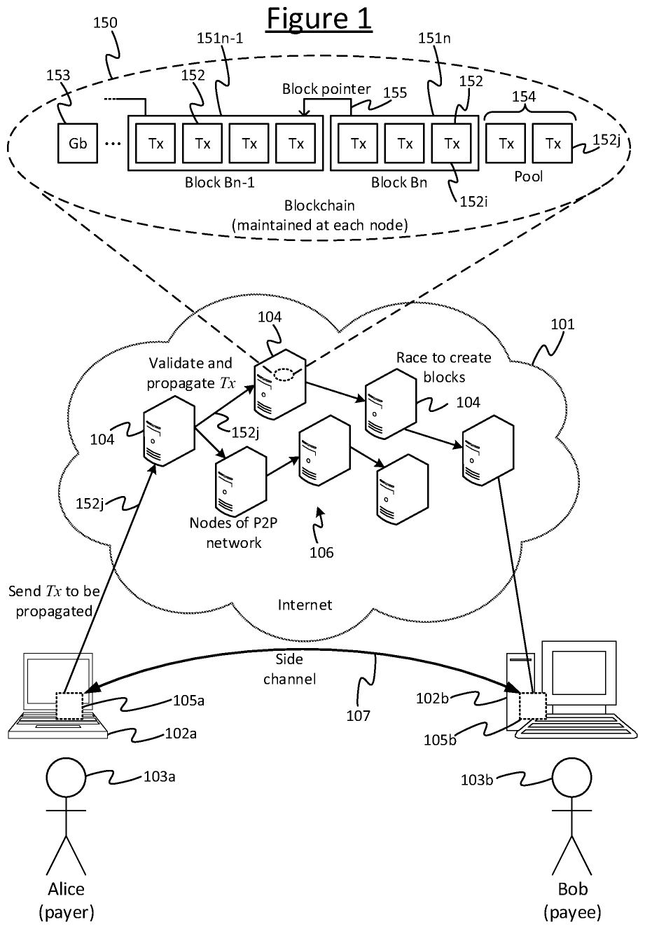

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### UTXO-Based Model

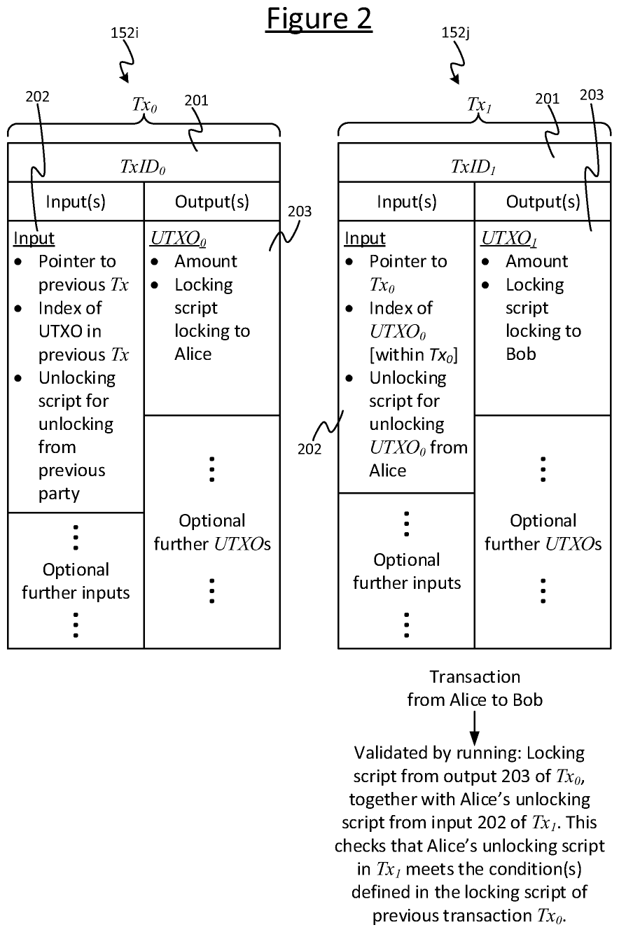

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><P_{A}>∥[Checksig P_{A}]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### Client Software

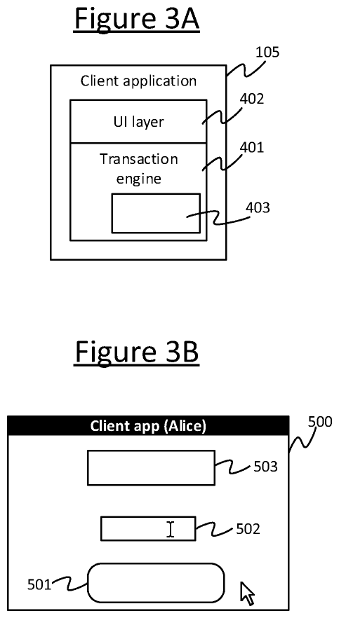

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to generate a signature to be embedded within a transaction.

Alternatively or additionally, the UI elements may comprise one or more data entry fields 502, through which the user can enter data to be embedded within a signature. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

Cryptography Preliminaries

ECDSA—Elliptic Curve Groups

(E,⊖) is a cyclic elliptic curve group over finite field [symbol] ₚ where p is prime. The number of elements in E is n where n is prime. G∈E is the generator point of the elliptic curve group, meaning:

∀Y∈E∃i∈{1, . . . ,n}:Y=i·G.

The group operation ‘⊖’ is standard elliptic curve point addition and i·G denotes i repetitions of the group operation on G

$$i \cdot G = {\underbrace{G ⊕ G ⊕ … ⊕ G}}_{i times}$$

In the following all operations on integers are modulo n unless the context requires otherwise.

Elliptic Curve Digital Signature Algorithm

Key generation is done as follows:
1) Choose a private signing key j∈{1, . . . , n−1}
2) The public key is Y=j·G where G is the generator point

The signing algorithm takes the private key j message m and an ephemeral key k and generates the signature:
3) Choose random k∈{1, . . . , n−1} (ephemeral key)
4) Calculate R=(rₓ, r_{y})=k·G−EC point
5) Calculate r=rₓ mod n
6) If r=0 go to step 3
7) Generate signature s=k⁻¹(e+jr) where e=hash(m).
8) If s=0 go to step 3
9) Output [r, s] as the signature for message m

The verification algorithm then takes the signature and message and reconstructs r using the signer's public key and verifies the r value given in the signature.
1) Calculate e=hash(m)
2) Calculate k₁=es⁻¹ mod n and k₂=rs⁻¹ mod n
3) Calculate Q=(qₓ, q_{y})=k₁·G+k₂·Y
4) If qₓ≡r mod n then the signature is valid. Otherwise invalid.

The following notation is used for the signature:

Sig_{Y}=[r_{Y},s_{Y}],

where [r_{Y}, s_{Y}] is a valid signature when verified using the public key Y.

Joint Verifiable Random Secret Sharing (JVRSS)

Assume that N participants want to create a joint secret that can only be regenerated by at least (t+1) of the participants in the scheme. To create the shared secret, the following steps are taken:
1) The participants agree on the unique label i for each participant. Each participant i generates (t+1) random numbers

aᵢⱼ∈_{R} [symbol] ₙ\{0},∀j=0, . . . ,t,
where ∈_{R} means a randomly generated element of the set [symbol] ₙ\{0} where [symbol] ₙ\{0} is notation for the set {1, . . . , n−1}. Then each participant has a secret polynomial of order t

fᵢ(x)=aᵢ₀+aᵢ₁x+ . . . +aᵢₜx^{t} mod n,
for i=1, . . . , N. Note that we omit the mod n notation from now on, and it is assumed that all arithmetic operations over integers are done modulo n.
2) Each participant i sends the value fᵢ(j) to participant j e.g. using a secure communication channel with participant j only.
3) Each participant i calculates their own private secret share of a shared secret polynomial as

$${a}_{i} := {\sum }_{j = 1}^{N} {f}_{j} ( i ) .$$

A shared secret share is a point with the form (i, aᵢ), where i is the participants label in the scheme. This method for creating a secret share of a, as described in steps 1-3, is denoted herein by aᵢ=JVRSS(i) for participant i. Note that “JVRSS” typically stands for “Joint verification random secret sharing” and includes steps 4 and 5 as well. However, throughout this document JVRSS is taken to mean performing at least steps 1 to 3, where steps 4 and 5 are optional steps.

Now that the participants have generated a shared polynomial, they can each verify that the other participants have shared the correct information to all participants, and that all participants have the same shared polynomial. This is done in the following way.
4) Each participant i broadcasts to all participants the obfuscated coefficients

aᵢₖ·G,
for k=0, . . . , t.
5) Each participant i checks that each participant j has correctly calculated the polynomial point fⱼ(i) by calculating fⱼ(i)·G and verifying that

$${f}_{j} ( i ) \cdot G {=}^{?} {\sum }_{k = 0}^{t} {i}^{k} ( {a}_{j k} \cdot G ) ∀ j = 1 , … , N .$$

If all participants find that this equation holds for each polynomial, then the group can collectively be sure that they have all created the same shared polynomial.

Reconstructing a shared secret Assume a participant wants to reconstruct a shared secret a which is the zeroth order of a shared polynomial. Given (t+1) points on this polynomial of the form

(1,a₁), . . . ,((t+1),aₜ₊₁),
then to find the shared secret a, one calculates

$$interpolate ( {a}_{1} , … , {a}_{t + 1} ) = ( {\sum }_{l = 1}^{t + 1} {a}_{l} {{\prod }_{1 \leq j \leq ( t + 1 ) ,}}_{j \neq l} ( - j ) {( l - j )}^{- 1} ) = a ,$$

which is derived from a general formula known as “Lagrange Interpolation”.

Public Key calculation

Given the N zeroth-order private polynomial coefficient public keys aᵢ₀·G for j=1, . . . , N shared in step 4 of JVRSS, each participant calculates the shared public key P using

$$P = a \cdot G = {\sum }_{j = 1}^{N} {a}_{j 0} \cdot G ,$$

corresponding to the shared secret a.

Addition of Shared Secrets

To calculate the addition of two shared secrets that are shared amongst a group of N participants, where each secret polynomial has order t, without any entity knowing the individual secrets, the following steps are taken:
1) Generate the first shared secret a, where participant i's share is given by aᵢ=JVRSS(i) for i=1, . . . , N with a threshold of (t+1).
2) Generate the second shared secret b, where participant i's share is given by bᵢ=JVRSS(i), with a threshold of (t+1).
3) Each participant i calculates their own additive share

νᵢ=aᵢ+bᵢ mod n
4) All participants broadcast their additive share vi to all other participants.
5) Each participant interpolates over at least (t+1) of the shares νᵢ to calculate

ν=interpolate(ν₁, . . . ,νₜ₊₁)=a+b.

This method for the addition of shared secrets is denoted by ADDSS(i) for participant i, which results in each participant i knowing ν=(a+b).

Product of Shared Secrets

To calculate the product of two shared secrets that are both shared amongst a group of N participants, where each secret polynomial has order t, the group takes the following steps:
1) Generate the first shared secret a, where participant i's share is given by aᵢ=JVRSS(i) for i=1, . . . , N. The shared secret polynomial has order t, meaning (t+1) participants are required to recreate it.
2) Generate the second shared secret b, where participant i's share is given by bᵢ=JVRSS(i), and the shared secret polynomial again has order t.
3) Each participant calculates their own multiplicative share μᵢ using

μᵢ=aᵢbᵢ.
4) All participants broadcast their multiplicative share μᵢ to all other participants.
5) Each participant interpolates over at least (2t+1) of the shares μᵢ at 0 to calculate

μ=interpolate(μ₁, . . . ,μ₂ₜ₊₁)=ab.

This method for calculating the product of two shared secrets is denoted herein by μ=ab=PROSS(i) for participant i.

Inverse of a Shared Secret

In order to calculate the inverse of a shared secret a, the following steps are taken:
1) All participants calculate the product of shared secrets PROSS(i), the result of which is

μ=ab mod n.
2) Each participant calculates the modular inverse of μ which results in

μ⁻¹=(ab)⁻¹ mod n.
3) Each participant i calculates their own inverse secret share by calculating

aᵢ⁻¹=μ⁻¹bᵢ.

This method for calculating the inverse of shared secrets is denoted by aᵢ⁻¹=INVSS(i) for participant i.

Shared Private Key Generation and Verification

To calculate a shared private key a between N≥2t+1 participants, t+1 of which are required to create a signature, the participants execute JVRSS with a threshold of t+1 and public key calculation as described above. The result is that every participant i=1, . . . , N has a private key share aᵢ and the corresponding shared public key P=(a·G).

Ephemeral Key Shares Generation

To generate ephemeral key shares and the corresponding r, as is required in a signature, a group of size N with a shared private key a of threshold (t+1) execute the following steps:
1) Generate the inverse share of a shared secret kᵢ⁻¹=INVSS(i), where (t+1) shares are required to recreate it.
2) Each participant calculates

$$( x , y ) = {\sum }_{i = 1}^{N} ( {k}_{i 0} \cdot G ) ,$$

3) using the obfuscated coefficients shared in the verification of kᵢ, then they calculate

r=x mod n.
4) Each participant i stores (r, kᵢ⁻¹).

Non-Optimal Signature Generation

Assume that at least 2t+1 participants would like to create a signature on a message, and one of the participants chooses to coordinate this. In order to create a signature by a group with the shared private key a, the following steps are taken.
1) The coordinator requests a signature on the message from at least 2t+1 participants.
2) Each participant i recovers the ephemeral key (r, kᵢ⁻¹) calculated in the previous section. All users must use a share corresponding to the same ephemeral key.
3) Each participant calculates the message digest e=SHA-256(SHA-256(message)).
4) Each participant i calculates their own signature share sᵢ:

sᵢ=kᵢ⁻¹(e+aᵢr)mod n,
where aᵢ is their private key share.
5) Each participant sends their signature share (r, sᵢ) to the coordinator.
6) When the coordinator has received 2t+1 signature shares, they calculate:

s=interpolate(s₁, . . . ,s₂ₜ₊₁),
and output the signature as (r,s).
7) The coordinator verifies the signature using the standard ECDSA verification. If this fails, at least one of the shares must be incorrect, and the signature generation algorithm should be run again.

Diffie-Hellman (DH) Key Exchange

Two parties may establish a secure communication channel by creating a symmetric secret key in the following way. Assume that Alice and Bob want to create a shared secret key, and that Alice has knowledge of the private key sk_{A} corresponding to the public key PK_{A}=sk_{A}·G and Bob knows the private key sk_{B} corresponding to his public key PK_{B}=sk_{B}·G.

In order to find the shared secret key, they do the following steps.
1) Alice calculates the Diffie-Hellman key sk_{AB}=sk_{A}·PK_{B}.
2) Bob calculates the Diffie-Hellman key sk_{AB}=sk_{B}·PK_{A}.

Another method for establishing a shared secret key is described in WO2017/145016 in which a pre-agreed message is added onto a DH key, creating a new key. This message can be changed with each new communication that is sent, creating a set of deterministic keys. For example, the message may be m=hash(date∥time). Alice can then use the message to generate a private key sk_{A1}=sk_{A}+hash(date∥time), and similarly Bob can generate a private key sk_{B1}=sk_{B}+hash(date∥time). Both Alice and Bob can then generate the shared private key sk_{AB1}=sk_{A1}·PK_{B1}=sk_{B1}·PK_{A1}.

HD Wallets

Hierarchical Deterministic wallets, of which a Bitcoin Improvement Proposal 32 (BIP32) wallet is a particular type, are deterministic wallets where many keys can be derived from a single input. The input is some random entropy called the seed, from which a master key is derived. The master key is then used to derive multiple child keys, as shown in FIG. 2.

In BIP32 the master private key is the left 32 bytes of the result of the HMAC-SHA512 of the seed, or explicitly, it is

skₘₐₛₜₑᵣ=HMAC-SHA512_{L}(‘Bitcoin Seed’,seed),

and the chain code is

cₘₐₛₜₑᵣ=HMAC-SHA512_{R}(‘Bitcoin Seed’,seed),

and all child keys can be then derived from these, where

HMAC-SHA512(c,K)=SHA512(c⊖opad∥SHA512((c⊖ipad)∥K))

is the HMAC using the SHA512 hash function. In the equation above, opad is the block-sized outer padding, and ipad is the block-sized inner padding.

A HMAC requires two inputs, i.e. c and K. For simplicity and so that users are only required to remember or store a single seed, the BIP32 protocol sets the first input as the string ‘Bitcoin Seed’, i.e. c=‘ Bitcoin Seed’ It will be appreciated that this is one example protocol for generating a HD wallet and that different protocols may require different inputs, e.g. two randomly generated seeds. In other words, the use of the string ‘Bitcoin Seed’ is not a necessary requirement for generating a HD wallet.

The equation for calculating a hardened child private key sk_{child} from a parent private key skₚₐᵣₑₙₜ is

sk_{child}=skₚₐᵣₑₙₜ+HMAC-SHAS512_{L}(cₚₐᵣₑₙₜ,skₚₐᵣₑₙₜ∥index),
where cₚₐᵣₑₙₜ is the parent chain code, 0≤index<2³¹ is the child index, and HMAC-SHA512_{L} is the left 32 bytes of the result of the HMAC function calculated with the SHA-512 hash function. The corresponding equation for the child public key is derived by simply point multiplying this equation by the base point G. The child chain code c_{child} is defined to be the right 32 bytes of the result of the HMAC function, c_{child}=HMAC-SHA512_{R}(cₚₐᵣₑₙₜ, skₚₐᵣₑₙₜ∥index).

The equation for calculating a non-hardened child private key sk_{child} from a parent public key pkₚₐᵣₑₙₜ and parent private key skₚₐᵣₑₙₜ is

sk_{child}=skₚₐᵣₑₙₜ+HMAC-SHA512_{L}(cₚₐᵣₑₙₜ,pkₚₐᵣₑₙₜ∥index),
where cₚₐᵣₑₙₜ is the parent chain code, 2³¹≤index<2³² is the child index, and HMAC-SHA512 is the HMAC function calculated with the SHA-512 hash function. Similar to hardened keys, the child chain code c_{child} for non-hardened keys is defined to be the right 32 bytes of the result of the HMAC function:

c_{child}=HMAC-SHA512_{R}(cₚₐᵣₑₙₜ,pkₚₐᵣₑₙₜ∥index).

This second type of child key allows for child public keys to be derived by anyone with knowledge of the parent public key and chain code using the equation

pk_{child}=pkₚₐᵣₑₙₜ+HMAC-SHA512_{L}(cₚₐᵣₑₙₜ,pkₚₐᵣₑₙₜ∥index)·G.

This can be used by external parties to derive various payment addresses as required, avoiding key reuse, whilst reducing rounds of communication and storage.

In general, a HD wallet should generate some hierarchical tree-like structure of private-public key pairs. This provides a high number of key pairs that can all be regenerated from one seed.

Threshold Digital Signatures

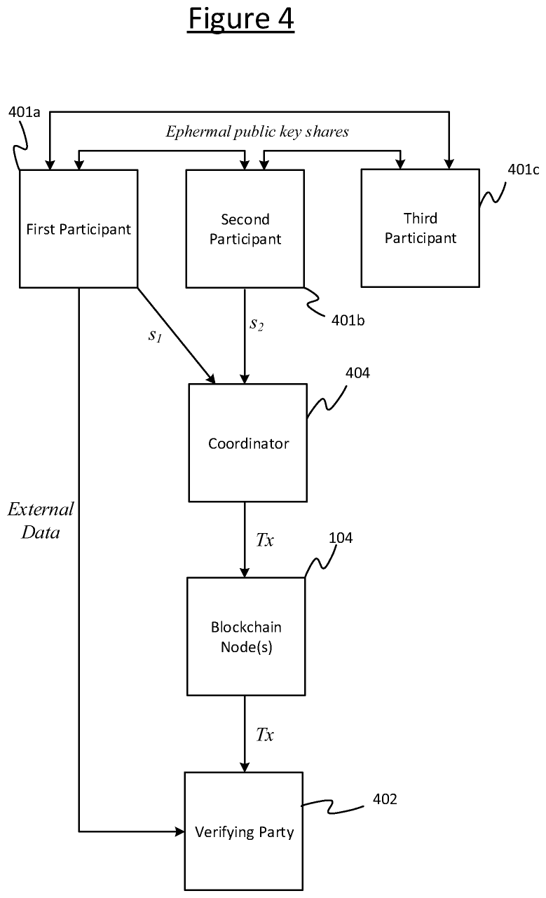

FIG. 4 illustrates an example system 400 for generating a digital signature according to some embodiments of the present invention. The system comprises a plurality of participants 401 who each have a respective share of a shared private key. The shared private key may have been generated using a secret sharing scheme, e.g. JVRSS or Shamir's secret sharing scheme. The shared private key may have been generated using a scheme with a dealer, or using a dealer-less scheme. Only three participants are shown in FIG. 4, but in general the system may comprise any number of participants 401. The system also comprises a verifying party 402, i.e. a signature verifying party, and a coordinator 404. The coordinator 404 is configured to generate a signature based on a threshold number of signature shares, each signature share being generated by a respective participant. Whilst the coordinator 404 is shown as being distinct in FIG. 4, in some examples the coordinator may be the same entity as one of the participants, e.g. the first participant 401a. In some examples, the system comprises one or more blockchain nodes 104.

Each participant 401, verifying party 402, and coordinator 404 operates respective computing equipment (not shown). Each respective computing equipment comprises respective processing apparatus comprising one or more processors, e.g. one or more central processing units (CPUs), accelerator processors (GPUs), application specific processors and/or field programmable gate arrays (FPGAs). The respective computing equipment may also comprise memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive. The respective computing equipment may comprise at least one user terminal, e.g. a desktop or laptop computer, a tablet, a smartphone, or a wearable device such as a smartwatch. Alternatively or additionally, the respective computing equipment may comprise one or more other networked resources, such as cloud computing resources accessed via the user terminal (the cloud computing resources comprising resources of one or more physical server devices implemented at one or more sites). It will be appreciated that any act described as being performed by a party of the system 400 may be performed by the respective computing apparatus operated by that party.

Whilst the present invention is not limited only to use in a blockchain context, the following will be described with the first participant 401a being equated to Alice 103a as described with reference to FIGS. 1 to 3. That is, in some examples Alice 103a is the first participant 401a. The verifying party 402 will be referred to below as Carol 402

In these embodiments, Alice 401a would like to generate a share of a signature for a message, and prove to Carol 402 that she generated that signature share.

Alice 401a obtains the message to be signed, e.g. some or part of a blockchain transaction, a document, or a contract, etc. Alice 401a may generate the message herself, or Alice 401a may receive the message, e.g. from another participant 401 or the coordinator 404. Alice 401a also obtains an external data item. Alice 401a may already have the external data item, e.g. a name, passport number, public key, etc., or Alice 401a may generate the external data item. For instance, and as will be described in more detail below, the external data item may be a signature (a “second signature”) generated by Alice 401a.

Alice 401a generates an ephemeral private key share based on a hash of the external data item. Each other participant, e.g. the second and third participants 401b, 401c, also generate a respective ephemeral private key share. Preferably the other participants generate their respective ephemeral private key shares based on a hash of a respective external data item, but that is not essential.

Regardless of whether the other participants ephemeral private key shares are based on of their respective external data items, each participant's ephemeral private key share is generated based on an input (a “data item”) generated by each other participant. I.e. Alice's ephemeral private key share is generated based on a respective data item from all of the other participants, and the other participant's respective ephemeral private key shares are a function of a data item from Alice. As a particular example, each participant may generate a respective data item (e.g. the zeroth-order coefficient of a polynomial) that is based on their respective external data items. To preserve privacy, the data items may be shared using a secret sharing scheme. The participants may use the JVRSS scheme described above, where participants share polynomials evaluated at an index of the other participants. The JVRSS scheme is modified slightly by computing the zeroth order coefficient of the polynomial as based on the external data item, as opposed to being generated randomly. This is discussed in more detail below.

Alice's ephemeral private key share is now a function of the result of hashing her external data item. The hash function used to generate the hash of the external data item may be any suitable hash function, e.g. SHA256, SHA512, and may comprise applying one or more hash functions multiple times. For instance, the hash function may be a double-hash function, e.g. SHA256d(x)=SHA256(SHA256(x)).

The signature share generated by Alice 401a requires the ephemeral private key share, or depending on the particular signature algorithm, the inverse of the ephemeral private key share. So that the respective ephemeral private key shares remain private to the respective participants, e.g. so that only Alice 103a knows her respective ephemeral private key share, the participants may use a secret sharing scheme to generate their respective ephemeral private key shares, i.e. each participant shares enough information with the other participants so that they can each generate a share of the same secret, but without actually generating or the secret itself. In this case the shared secret is an ephemeral private key. For instance, the participants may use a modified version of JVRSS. The steps of JVRSS are detailed above. In this modified version, call it JVRSS-A, in step 1) the participants set the zeroth-order coefficient aᵢ₀ of their respective private polynomial as being equal to the hash (e.g. double-hash) of the respective data item. The other polynomial coefficients may be chosen at random as in the normal JVRSS. The remaining steps of 1) to 5) of JVRSS are then followed as normal. Each participant then has a respective ephemeral private key share, and a set of obfuscated data items (i.e. public keys corresponding to the data items), one for each other participant. Note that JVRSS, or rather JVRSS-A, is a particular example of a secret sharing scheme and other scheme may be used, e.g. Shamir's secret sharing scheme.

Alice 401a generates a public key corresponding to her data item. E.g. by obfuscating the data item with a generator point. Alice 401a obtains a respective public key from each other participant 401, and uses the public keys to generate an ephemeral public key corresponding to the ephemeral private key. For instance, the participants may use JVRSS-A to generate the ephemeral public key. Note that “ephemeral public key” is being used as shorthand here for the x-component (or x-coordinate) of the ephemeral public key.

Having generated the ephemeral private key share and the ephemeral public key (i.e. a public key corresponding to the shared ephemeral private key), Alice 401a can then generate her signature share. Alice's signature share is generated based on the message (e.g. a blockchain transaction), her respective share of the shared private key, the (inverse) ephemeral private key share and the ephemeral public key. Note again that depending on the particular signature scheme being used, the signature share may be generated based on the inverse of the ephemeral private key. Either way, given that the ephemeral private key share is generated based on an external data item, that external data item is now embedded within the signature share.

Alice 401a may then send her signature share to the coordinator 404 who can then generate the first signature based on Alice's signature share and one or more respective signature shares generated by respective participants 401. The coordinator 404 requires a threshold number of signature shares in order to generate a valid signature. As mentioned briefly above, Alice 401a may in fact be the coordinator 404. In that case she already has access to her signature share and then receives respective signature shares from other participants 401.

The signature therefore incorporates an external data item known, at this point, only to Alice 401a, e.g. a personal identifier. Note that the external data item itself need not be a secret. It is preferred that the fact that the external data item is embedded within the signature is initially kept secret, but this is not essential. For example, the external data item may be a certified public key of Alice's which itself is known to one or more parties, but its use as the external data item is not known.

In order to prove that she generated a share of the first signature, Alice 401a may make the signature available to Carol 402. E.g. Alice 401a may send the signature to Carol 402, or Alice may publish or otherwise broadcast the signature. In other examples, Carol 402 may obtain the signature from a different party, e.g. the coordinator 404. Alice 401a may also send the message to Carol 402. Preferably the signature and the message are sent or published together.

Alice 401a may also make the external data item available to Carol 402, either at the same time as the signature or at a different time, e.g. at a later time. The external data item may be made available in the same way as the signature or in a different way. For example, Alice 401a may send the external data item to Carol 402 via a secure communication channel. In order to verify that Alice 401a generated a signature share Carol 402 requires the respective public keys corresponding to the respective data items generated by the other participants 401 (e.g. the public keys that obfuscate the zeroth-order coefficients). Alice 401 may send these to Carol 402, or the other participants may send their respective ephemeral public key shares to Carol 402.

As mentioned above, the external data item may be, or at least include, another signature. In that case, Alice 401a obtains a second message and generates a second signature based on at least the second message and a “main private key”. In the broadest examples, “main” is used merely as a label. That is, the main private key may be any private key owned by Alice 401a.

Alice 401 may generate at least part of the second message herself. Additionally or alternatively, Alice 401a may receive or otherwise obtain at least part of the second message from another party, e.g. Carol 402. That is, Carol 402 may send some or all of the second message to Alice 401a, or Alice 401a and Carol 402 may have previously agreed upon at least part of the second message. For instance, Alice 401a and Carol 402 may have agreed to include an indication of the data and/or time at which the second signature is generated. In some examples, the second message may comprise or be generated based on the first message. For instance, the second message may comprise the first message with additional data concatenated onto the start or end of the first message.

In some examples, each participant 401 uses the same second message to generate a respective second signature. That is, each participant 401 generates a respective second signature based on the second message and a receptive main private key.

Alice 401a may send at least the second signature to Carol 402, or Alice 401a may publish the second signature. If Carol 402 does not already have access to the second message, Alice 401a sends it to Carol 402, or she may publish the second message. Alice 401a may also send a main public key corresponding to the main private key to Carol 402, or at least indicate where Carol 402 may obtain the main public key from, e.g. a location storing a certificate issued by a certificate authority and certifying the main public key as being linked to Alice 401a.

The ephemeral private key share is based on (i.e. is a function of) at least a hash of the external data item, e.g. a double-hash of the second signature. The ephemeral private key share may also be based on a randomly generated salt value, i.e. a value added to the hash of the external data item. More specifically, the data item used to generate Alice's ephemeral private key share may be based on the salt value. Preferably a salt value is used only once, i.e. a different salt value is used to generate different instances of the first signature. In these examples, Alice 401a may generate a third signature based on a third message and the salt value. That is, the salt value is used as a private key for generating the third signature. The third message may be generated based on the first and/or second messages. The third message may be the same as the second message. Alice 401a may send the third signature to Carol 402. If Alice 401a has generated the third message, she may also send it to Carol 402. Or, Carol 402 may have sent the third message to Alice 401a in which case Alice 401a does not need to re-send it to Carol 402, although she may choose to do so.

As an alternative to generating a third signature, Alice 103a may instead prove knowledge of the random salt value using a zero-knowledge proof (ZKP). The skilled person will be familiar with ZKPs per se and so will not be described here in detail. An example ZKP is provided below.

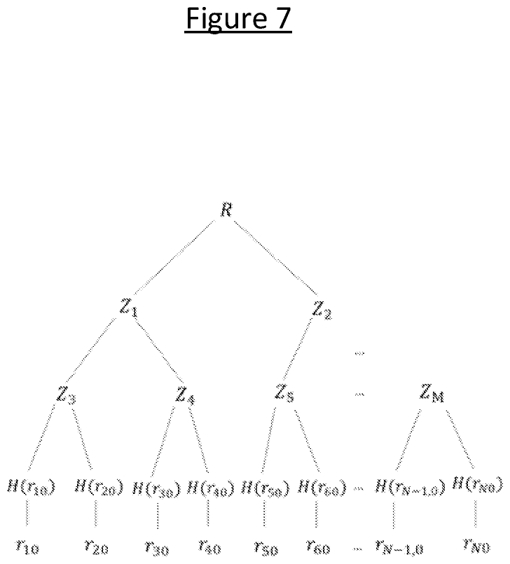

Optionally, Alice 401a may generate a hash tree, e.g. a Merkle tree, using the respective public keys corresponding to the data items, i.e. the public key generated by Alice 401a and the public key obtained from the other participants. Each of these public keys is hashed to form a respective leaf hash of the hash tree. Alice 401a may transmit the resulting hash root (e.g. a Merkle root) to Carol 402, or she may publish the hash root. At the same time or at a later time, Alice 401a may send a hash proof (e.g. a Merkle proof) to Carol 402 to prove that Alice's public key is an element of the hash tree. In some examples, the first message includes the hash root and so each participant that generates a signature share attests to the same hash root. That is, they attest to the public keys that have been used to generate the hash root. An example hash root is shown in FIG. 7.

As mentioned above, embodiments of the present invention are not limited to use with the blockchain 150. However in those that are, the first message may be a blockchain transaction. For instance, Alice 401a may generate a share of a signature that is used to sign some or all of a blockchain transaction, e.g. one or more inputs and/or one or more outputs of the transaction. The coordinator 404 may then include the first signature in an input of the transaction that she has not signed. The transaction may comprise an output that is locked to a different party, e.g. Bob 103b and/or Carol 402, e.g. the output may be a pay-to-public-key (P2PK) or pay-to-public-key-hash (P2PKH) output locked a public key owned by Bob 103b. The second message may comprise the transaction. The second message may also comprise data relating to the blockchain 150, e.g. a current block height of the blockchain at the time the transaction is generated. In these examples, Alice 401a or the coordinator 404 may make the first message available to Carol 402 by transmitting the transaction to the blockchain 150, from which Carol 402 may then access. This is illustrated in FIG. 4. The hash root may be included in an output of the blockchain transaction.

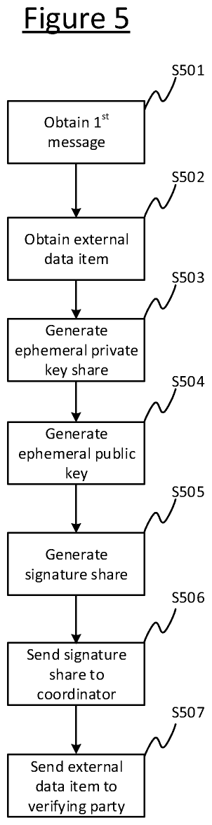

FIG. 5 illustrates an example sequence of steps which may be taken by Alice 401a to generate a signature share according to some embodiments of the present invention. It will be appreciated that some of the steps may be performed in a different order. In step S501, Alice 401a obtains a first message, e.g. a blockchain transaction. In step S502, Alice 401a obtains an external data item, e.g. a second signature. In step S503, Alice 401a generates an ephemeral private key share based on the external data item, e.g. based on a hash of the second signature. In step S504, Alice 401a generates an ephemeral public key which corresponds to the shared ephemeral private key. In step S505 Alice 401a generates a signature share and in step S506 she sends it to the coordinator 404. After the coordinator 404 has generated the signature and it is available to Carol 402, Alice 401a sends at least the external data item to Carol 402.

The actions taken by the verifying party, Carol 402, will now be described. Carol 402 would like Alice 401a to prove that Alice 401a generated a share of the first signature. Carol 402 obtains the first signature. Alice 401a may send the first signature to Carol 402, or the first signature may be publicly accessible, e.g. recorded on the blockchain 150. If the first signature is included in an input of a blockchain transaction, Carol 402 obtains the first signature by extracting it from the transaction. Carol 402 also obtains a candidate external data item from Alice 401a. Here, “candidate” is used to refer to an external data item that Alice 401a claims to have been embedded within the first signature, i.e. in her respective signature share. If that is indeed the case, the candidate external data item is the same as the external data item discussed above. However at this point Carol 402 cannot confirm that to be the case, hence the term “candidate”.

Carol 402 uses the candidate external data item to generate a candidate ephemeral public key. To do this, Carol obtains Alice's external data item (or the first data item, if it is generated based on more than just the external data item) and generates a corresponding public key. Carol 402 also obtains public keys corresponding to the other participants data items. Carol 402 generates the candidate ephemeral public key using the candidate and obtains public keys. The candidate ephemeral public key comprises a first component and a second component, e.g. an x value and a y value.

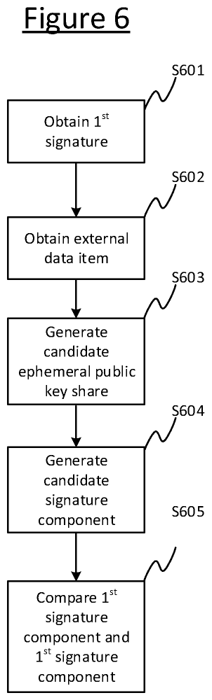

The first signature obtained by Carol 401 comprises a first signature component and a second signature component. To verify that Alice 401a contributed to the first signature, Carol 402 compares the candidate first signature component to the first component of the candidate ephemeral public key. If they match, Carol 402 can be sure that Alice 401a did indeed generate a share of the first signature. That is, in order for the first component of the candidate ephemeral public key (which comprises an x-component equivalent to a candidate first signature component) and the first signature component to be a match, the candidate external data item must be the external data item used to generate Alice's signature share. Since Alice 401a provided Carol 402 with the candidate external data item, this proves that Alice 401a generated a share of the signature. This process is illustrated in steps S601 to S605 of FIG. 6.

Carol 402 may also verify that the first signature is a valid signature when validated against the corresponding public key. If the first signature is used to sign a blockchain transaction and that transaction has been recorded on the blockchain, Carol 401 may assume that the first signature is a valid signature (i.e. the transaction would not have been accepted by a blockchain node if the signature was not valid). However Carol 401 may still verify that the unlocking script that is being spent contains a signature check (i.e. to make sure that a blockchain node has performed a signature check on the signature during transaction validation). To do this, Carol 401 may check that the unlocking script of the spent transaction includes an OP_CHECKSIG script.

As discussed above when describing embodiments of the invention from Alice's perspective, the external data item may itself by a signature, i.e. a second signature. In this case, Carol 402 may obtain a second message, e.g. from Alice 401a, and verify that the second signature is a valid signature when verified using a public key provided by or otherwise linked to Alice 401a, e.g. a certified public key.

If Alice 401a has used a salt value to generate the ephemeral private key share used to generate the first signature, Alice 401a may provide Carol 402 with a public key corresponding to the salt value. Carol 402 may then generate the candidate first signature component based on the “salt public key”, e.g. based on a combination of the candidate ephemeral public key share and the salt public key. The x-value of said combination may be used to generate the candidate first signature component. An example is provided further below. In these examples, Alice 401a may also provide Carol 402 with a third signature and a third message. Carol 402 may verify that the third signature is a valid signature when verified using the salt public key. As another optional feature, Alice 401a may provide Carol 402 with a ZKP which Carol 402 may use to verify that Alice 401a knows the salt value.

The following describes a specific example of embedding identity data into secret shares used in dealerless ECDSA threshold signing.

A group of N participants A₁, . . . , A_{N} agree to form a threshold signature group. In order to generate the data needed to execute the modified JVRSS (JVRSS-A) assume that each participant 401 has a private key sk_{Ai} (“main private key”) and a corresponding public key PK_{Ai}=sk_{Ai}·G, for i∈{1, . . . , N}. The public key PK_{Ai} may be a certified public key, or derived from a certified public key.

The group agree on an attest message Mₐₜₜₑₛₜ (“second message”) which is public and will be used for attestation at a later point in time. Each group member 401 signs the attest message to generate a “second signature” (i.e. the external data item):

[r_{A}_{ᵢ},S_{A}_{_{i=Sig(}}Mₐₜₜₑₛₜ)PK_{Ai},i∈{1, . . . ,N}.

Each participant 401 also computes the (double) hash of their signature

SHA256d([r_{Ai},s_{Ai}]),

and obfuscates it with a generator point:

SHA256d([r_{A}_{ᵢ},s_{A}_{ᵢ}])·G.

The signature and hashed data will be used in both the threshold secret sharing and attest algorithm.

A shared secret between N participants can be generated using a secret sharing scheme, e.g. the JVRSS method described above. For the JVRSS-A variant the algorithm is modified by prescribing the zeroth-order (y-intercept). Follow steps 1)-5) of JVRSS with the following modification.

In Step 1) each participant 401 computes the zeroth-order of their private polynomials (instead of choosing the value at random):

$${f}_{{A}_{1}} ( 0 ) = {a}_{10} = SHA 256 d ( [ {r}_{{A}_{1}} , {s}_{{A}_{1}} ] ) , \\ {f}_{{A}_{2}} ( 0 ) = {a}_{20} = SHA 256 d ( [ {r}_{{A}_{2}} , {s}_{{A}_{2}} ] ) , \\ {f}_{{A}_{3}} ( 0 ) = {a}_{30} = SHA 256 d ( [ {r}_{{A}_{3}} , {s}_{{A}_{3}} ] ) , \\ ⋮ \\ {f}_{{A}_{N}} ( 0 ) = {a}_{N 0} = SHA 256 d ( [ {r}_{{A}_{N}} , {s}_{{A}_{N}} ] ) ,$$

All other polynomial coefficients are chosen at random.

The inverse of a shared secret between N participants can be calculated using the INVSS method described above. INVSS can be used to generate an N group ephemeral key and 2t+1 inverse shares. By using the attestation setup, INVSS is modified to incorporate ID embedding. This is simply so that to generate the shared ephemeral private key k (or rather, shares of the shared ephemeral private key, since the full private key itself is not actually generated), the participants 401 use the JVRSS-A method instead of the usual JVRSS.

The participants also create a Merkle tree using the public key corresponding to the zeroth order of the polynomial. The participants take the following steps.

1. Each participant 401 can use the obfuscated coefficients of participants from the JVRSS-A method rᵢ₀=kᵢ₀·G to calculate the following Merkle tree and corresponding Merkle root R, where each participant 401 has a respective data item kᵢ₀ generated based on the (double) hash of their signature, and a respective public key rᵢ₀ corresponding to the data item.

2. The participants 401 can then confirm that everyone has the same Merkle root by broadcasting this value to all participants 401. This Merkle root can then be included in the message that is signed using the corresponding ephemeral key.

Setup: N independent participants A₁, . . . , A_{N} agree to participate in a threshold secret sharing group. They also agree to use a trustless setup that enables future attestation. The participants use the attest message setup for the group of N particpants and also generate the attest message dependent group ephemeral key r (based on the sum of rᵢ₀). Note if the group want the attest message to be a transaction that is being signed, this step needs to be completed during the creation of the signature, once the message is known.

Each participant 401 follows JVRSS to calculate private key shares aᵢ=JVRSS(i). The public key is calculated by adding the obfuscated zeroth-order values of the private polynomials

PK=(f_{A}_{₁}^{a}(0)·G)+(f_{A}_{₂}^{a}(0)·G)+ . . . +(f_{A}_{_{N}}^{a}(0)·G).

Note that the threshold public key and private key share derivation are not modified. Private key share derivation should follow JVRSS without attestation.

A subset of 2t+1 participants A₁, . . . , A₂ₜ₊₁ wish to sign a transaction paying to PK_{B}.

They follow steps 1)-7) of “Non-optimal signature generation” described above using the attest message dependent ephemeral key r as part of the signature input. Note that an optimal signature generated method may be used instead. A summary is given below.

Every signing participant 401 agrees on a transaction Tx′_{threshold} (see table below).

Tx′_{threshold}

| Inputs | | Outputs | |
|---|---|---|---|
| Value | ScriptSig | Value | ScriptPubkey |
| 1 | | 0.99 | OP_DUP OP_HASH160 < |
| BSV | | BSV | H₁₆₀(PK_{B}) > OP_EQUALVERIFY |
| | | | OP_CHECKSIG |
| | | 0 | OP_FALSE OP_RETURN R |
| | | BSV | |

Each participant 401 calculates the message digest e=SHA-256d(Tx′_{threshold}).

Each participant 401 computes signature shares sᵢ=kᵢ⁻¹(e+aᵢr) mod n, where kᵢ⁻¹ (the inverse of the respective ephemeral private key share) and r (the public key corresponding to the shared ephemeral private key) are derived using the method described above.

A coordinator 404 collects the signature shares and interpolates:

s=interpolate(s₁, . . . ,s₂ₜ₊₁).

The output (“first signature”) is [r, s] and the transaction can be signed (see table below for the complete transaction).

Tx_{threshold}

| Inputs | | Outputs | |
|---|---|---|---|
| Value | ScriptSig | Value | ScriptPubkey |
| 1 | <[r, s]> <PK> | 0.99 | OP_DUP OP_Hash160 < |
| BSV | | BSV | H₁₆₀(PK_{B}) > OP_EQUALVERIFY |
| | | | OP_CHECKSIG |

The identity of participants A₁, . . . , A_{N} have now been embedded into the ephemeral key r, and therefore the first signature. Given Mₐₜₜₑₛₜ (which may be provided or publicly known), a participant 401 can prove that they are a member of a threshold group.

Assume that Alice 401a is participant A₁ with private identity key sk_{A1}. The value Mₐₜₜₑₛₜ is public and Alice 401a can generate the second signature:

[r_{A}_{₁},s_{A}_{₁}]=Sig(Mₐₜₜₑₛₜ)PK_{A1}

As a result of executing the algorithm to generate the group public ephemeral key r she also holds public keys corresponding to the respective data items:

{k₂₀·G, . . . ,k_{N,0}·G},

and the corresponding Merkle root R that is embedded into Tx_{threshold}.

The verifier 402 knows the number of participants N and Tx_{threshold} with first signature [r, s].

To execute the attestation proof Alice 401a first provides Carol 402, the verifier, with

[r_{A}_{₁},s_{A}_{₁}]=Sig(Mₐₜₜₑₛₜ)PKA₁,{k₂₀·G, . . . ,k_{N0}·G).

Carol (the verifier) computes the candidate ephemeral public key (comprising an x component and a y component):

(x′,y′)=SHA256d([r_{A}_{₁},s_{A}_{₁}])·G+k₂₀·G+ . . . +k_{N0}·G,

and a candidate first signature component based on the x component of the candidate ephemeral public key:

r′=x′ mod n.

and checks that r′=r (i.e. the candidate first signature component matches the first signature component).

Carol also verifies that [r,s] is a valid signature when validated using the group public key PK, where PK=a·G.

The following describes a Merkle proof attestation. Assume that Carol 402 knows the Merkle root R. Alice generates a Merkle proof to demonstrate that [SHA256d([r_{A}_{₁}, s_{A}_{₁}])·G] is an element of the set represented by R. Note, Alice 401a will have received all the ephemeral key shares from other group members during setup, and therefore will be able to regenerate the entire Merkle tree to generate a proof.

There is an attack where a verifier can go to all the participants and obtain enough information to create the shared ephemeral private key k, and then use the result along with the signature to derive the shared private key. In order to prevent this, Alice 401a can include a secret salt value. Explicitly, the zeroth order of participant i's ephemeral key may be set as:

f_{A}_{ᵢ}(0)=kᵢ₀=SHA256d([r_{A}_{₁},s_{A}_{₁})+w.

Alice 401a can then prove knowledge of this by either providing a zero-knowledge proof or by providing a signature generated with w. This salt should be kept secret.

Note that this method has been described in relation to the message being a transaction, but the message that the signature is on does not need to be restricted to this.

The following is a discussion of several security aspects of the described method.

The use of a salt value to mask the ephemeral key share k_{A1} serves as a protection against spoofing attacks. If it were the case that the ephemeral key depended only on the first transaction signature (with no additional randomness), an adversary may be able to replay the proof to others by simply retaining the information they have received from Alice (prover), making it difficult to distinguish the original transaction signer from someone who has simply seen a proof.

Employing the use of a one-time secret value in the signature-to-signature map guarantees that, not only are all private keys safe, but an adversary will be unable to use any information they have gained to impersonate Alice 401a. Hence the method does not require Carol (verifier) 402 to be an honest or trusted party.

The threshold signer proof may be vulnerable to spoofing unless the Merkle proof is provided. If the Merkle proof is not included as part of the attestation, and if the attest message is publicly known a non-group member can reverse engineer the proof data.

If Eve (eavesdropper) knows (x′,y′) where r′=x′ mod n, and the group attest message Mₐₜₜₑₛₜ then she can take her own private key sk_{E} and generate a signature [r_{E}, s_{E}]=Sig(Mₐₜₜₑₛₜ)PK_{E}.

She then can compute U=(x′, y′)−SHA256d([r_{E}, S_{E}])·G, and trivially divide U into parts U₁, U₂, . . . , U_{N-1} where U=U₁+ . . . +U_{N}.

Eve can use the calculated data to pretend she was a participant in a group signing event. No secret information from the actual group signers will be leaked, but a third party can pretend that they participated in a group signing event.

By including the Merkle root in the message that is signed by the group, this spoof is not possible.

### CONCLUSION

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In non-preferred embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of generating a share of a digital signature, wherein each participant of a group of participants has a respective share of a first shared private key, and wherein the method is performed by a first participant of the group and comprises:
obtaining a first message;
generating a first data item based on at least a hash of a first external data item; generating a first ephemeral private key share of an ephemeral private key, wherein the first ephemeral private key share is generated based on the first data item and a respective data item generated by each other participant;
generating an ephemeral public key corresponding to the ephemeral private key; generating a first signature share based on the first message, the first ephemeral private key share, a first share of the first shared private key, and the ephemeral public key; and
making the first signature share available to a coordinator for generating a first signature based on at least a threshold number of respective signature shares.

The external data item may comprise an identifier of the first party, e.g. a name, address, phone number, national insurance number, passport number, public key, etc.

Preferably the first signature is an ECDSA signature. The “ephemeral public key” is used as shorthand for “x-component of the ephemeral public key”.

Preferably each other participant generates their respective ephemeral public key shares in the same way and based on a respective external data item.

Statement 2. The method of statement 1, wherein the generating of the first ephemeral private key share comprise performing a secret sharing scheme with each of the other participants.

Statement 3. The method of statement 2, wherein the secret sharing scheme is a joint verifiable secret sharing (JVRSS) scheme.

More precisely, the secret sharing scheme may be a modified version of the JVRSS scheme where instead of each participant generating random polynomial coefficients, each participant instead sets the zeroth-order coefficient as the hash of a first external data item. The random polynomial coefficients may be truly random or pseudorandom (e.g. chosen arbitrarily).

Statement 4. The method of statement 3, wherein the first data item is a zeroth-order coefficient of a first polynomial, and wherein the JVRSS scheme comprises:
transmitting a respective instance of the first polynomial to each of the other participants, wherein the respective instance of the first polynomial is generated based on a respective index of the respective participant; and
obtaining a respective polynomial from each other participant, wherein the respective polynomial is generated based on a respective index of the first participant and the respective data item generated by that other participant.

Statement 5. The method of any preceding statement, wherein generating the ephemeral public key corresponding to the ephemeral private key comprises:
generating a first public key corresponding to the first data item; and
obtaining, from each other participant, a respective public key corresponding to the respective data item generated by that other participant.

Statement 6. The method of statement 5, comprising making the first external data item and the obtained respective public keys corresponding to the respective data items available to a verifying party for proving that the first participant generated the first signature.

Statement 7. The method of any preceding statement, wherein obtaining the first message comprises generating the first message, and wherein the method comprising making the first message available to the verifying party.

Statement 8. The method of any preceding statement, comprising:
obtaining a second message; and
generating a second signature based on at least the second message and a main private key of the first participant, and wherein the external data item comprises the second signature.

Statement 9. The method of statement 8, wherein each participant generates their respective external data item based on the same second message.

Statement 10. The method of statement 8 or statement 9, wherein the main private key of the first participant corresponds to a main public key linked to an identity of the first participant.

Statement 11. The method of any preceding statement, wherein the first share of the first shared private key is generated using a secret sharing scheme.

E.g. JVRSS.

Statement 12. The method of any preceding statement, wherein the first participant is the coordinator, and wherein the method comprises:
receiving at least the threshold number of respective signature shares; and
generating the first signature comprising first and second signature components, wherein the first signature component is generated based on the ephemeral public key, and wherein the second signature component is generated based on at least the threshold number of respective signature shares.

Statement 13. The method of any preceding statement, wherein the first data item is generated based on a random salt value.

Statement 14. The method of statement 13, wherein the method comprises providing the verifying party with a zero-knowledge proof for proving knowledge of the random salt value.

Statement 15. The method of statement 13 or statement 14, wherein the random salt value is a private key, and wherein the method comprises:
obtaining a third message;
generating a third signature based on at least the random salt value and the third message; and
making the third signature, the third message and a public key corresponding to the random salt value available to the verifying party for proving that the third signature is a valid signature for the third message when verified using the public key corresponding to the random salt value.

Statement 16. The method of statement 15, wherein the third message comprises the second message.

E.g. the third message may be the same as the second message.

Statement 17. The method of any preceding statement, comprising:
generating a root hash of a hash tree, wherein each respective public key corresponding to the respective data item is hashed to generate a respective leaf hash of the hash tree; and
transmitting the root of the hash tree to one or more of the participants and/or the verifying party.

Statement 18. The method of statement 15, comprising transmitting a hash proof to the verifying party for verifying that the first public key corresponding to the first data item is an element of the hash tree.

Preferably the hash tree is a Merkle tree, the hash root is a Merkle root, and the hash proof is a Merkle proof.

Statement 19. The method of any preceding statement, wherein the first message comprises at least part of a blockchain transaction.

For instance, the first signature may be used to sign the blockchain transaction.

Statement 20. The method of statement 18 and statement 19, wherein the blockchain transaction comprises the hash root.

Statement 21. The method of statement 19 or statement 20, wherein the blockchain transaction comprises the first signature.

Statement 22. The method of any of statements 19 to 21, wherein making the first message available to the verifying party comprises transmitting the blockchain transaction to the blockchain network.

Statement 23. The method of any preceding statement, wherein the hash of the external data item is a double-hash of the external data item.

Statement 24. A computer-implemented method of verifying that a digital signature has been partly generated by a first participant, wherein the method is performed by a verifying party and comprises:
obtaining a first signature comprising first and second signature components;
obtaining a candidate first external data item from the first participant, and one or more respective public key corresponding to a respective data items, one for each other participant;
generating a candidate public key based on a hash of the candidate first external data item;
generating a candidate ephemeral public key based on the candidate public key and the obtained one or more public keys;
generating a candidate first signature component based on the candidate ephemeral public key; and
verifying that the first signature has been partly generated by the first participant based on whether the candidate first signature component corresponds to the first signature component.

Statement 25. The method of statement 24, wherein the first signature signs a first message, and wherein the method comprises:
obtaining a shared public key corresponding to a shared private key used to generate the first signature; and
verifying that the first signature is a valid signature for the first message when verified using the first public key.

Statement 26. The method of statement 24 or statement 25, wherein the candidate external data item is a second signature.

Statement 27. The method of any of statements 24 to 26, wherein the second signature signs a second message, and wherein the method comprises:
obtaining a second public key corresponding to a private key used to generate the second signature; and
verifying that the second signature is a valid signature for the second message when verified using the second public key.

Statement 28. The method of any of statements 24 or statement 27, wherein the candidate public key is generated based on a random salt value, and wherein the method comprises: receiving a zero-knowledge proof for proving knowledge of the random salt value; and verifying that the first participant has knowledge of the random salt value.

Statement 29. The method of any of statements 24 to 28, wherein the candidate public key is generated based on a random salt value, and wherein the method comprises:
obtaining a third message;
obtaining a third signature; and
verifying that the third signature is a valid signature for the third message when verified using a public key corresponding to the random salt value.

Statement 30. The method of any of statements 24 to 29, comprising:
obtaining a hash proof and a hash root, wherein the first message comprises the hash root; and
verifying, based on the hash proof, that the candidate first ephemeral public key share is an element of a hash tree comprising the hash root.

Statement 31. The method of any of statements 24 to 30, wherein the first signature is received from the first party.

Statement 32. The method of any of statements 24 to 31, wherein the first message is received from the first participant.

Statement 33. The method of any of statements 24 to 31, wherein the first message is generated by the verifying party.

Statement 34. The method of any of statements 24 to 33, wherein the first message comprises at least part of a blockchain transaction.

Statement 35. The method of statement 34, wherein obtaining the first message comprises obtaining the blockchain transaction from the blockchain.

Statement 36. The method of statement 35, wherein obtaining the first signature comprises extracting the first signature from the blockchain transaction.

Statement 37. The method of any of statements 33 to 36, wherein an input of the blockchain transaction comprises the first signature, and wherein the method comprises:
verifying that an output of a previous blockchain transaction referenced by the input of the blockchain transaction comprises a signature verification script.

Statement 38. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 37.

Statement 39. A computer program embodied on computer-readable storage and configured so as, when run on one or more processors, to perform the method of any of statements 1 to 37.

According to another aspect disclosed herein, there may be provided a method comprising the actions of the first participant and the verifying party.

According to another aspect disclosed herein, there may be provided a system comprising the computer equipment of the first participant and the verifying party.

1. A computer-implemented method of generating a share of a digital signature, wherein each participant of a group of participants has a respective share of a first shared private key, and wherein the method is performed by a first participant of the group and comprises:
obtaining a first message;
generating a first data item based on at least a hash of a first external data item;
generating a first ephemeral private key share of an ephemeral private key, wherein the first ephemeral private key share is generated based on the first data item and a respective data item generated by each other participant;
generating an ephemeral public key corresponding to the ephemeral private key;
generating a first signature share based on the first message, the first ephemeral private key share, a first share of the first shared private key, and the ephemeral public key; and
making the first signature share available to a coordinator for generating a first signature based on at least a threshold number of respective signature shares.

2. The method of claim 1, wherein the generating of the first ephemeral private key share comprise performing a secret sharing scheme with each of the other participants.

3. The method of claim 2, wherein the secret sharing scheme is a joint verifiable secret sharing (JVRSS) scheme.

4. The method of claim 3, wherein the first data item is a zeroth-order coefficient of a first polynomial, and wherein the JVRSS scheme comprises:
transmitting a respective instance of the first polynomial to each of the other participants, wherein the respective instance of the first polynomial is generated based on a respective index of the respective participant; and
obtaining a respective polynomial from each other participant, wherein the respective polynomial is generated based on a respective index of the first participant and the respective data item generated by that other participant.

5. The method of claim 1, wherein generating the ephemeral public key corresponding to the ephemeral private key comprises:
generating a first public key corresponding to the first data item; and
obtaining, from each other participant, a respective public key corresponding to the respective data item generated by that other participant.

6. The method of claim 5, comprising making the first external data item and the obtained respective public keys corresponding to the respective data items available to a verifying party for proving that the first participant generated the first signature.

7. The method of claim 6 wherein obtaining the first message comprises generating the first message, and wherein the method comprising making the first message available to the verifying party.

8. The method of claim 1, comprising:
obtaining a second message; and
generating a second signature based on at least the second message and a main private key of the first participant, and wherein the external data item comprises the second signature.

9. The method of claim 8, wherein each participant generates their respective external data item based on the same second message.

10. The method of claim 8, wherein the main private key of the first participant corresponds to a main public key linked to an identity of the first participant.

11. The method of claim 1, wherein the first share of the first shared private key is generated using a secret sharing scheme.

12. The method of claim 1 wherein the first participant is the coordinator, and wherein the method comprises:
receiving at least the threshold number of respective signature shares; and
generating the first signature comprising first and second signature components, wherein the first signature component is generated based on the ephemeral public key, and wherein the second signature component is generated based on at least the threshold number of respective signature shares.

13. The method of claim 1, wherein the first data item is generated based on a random salt value, and wherein the method comprises providing a verifying party with a zero-knowledge proof for proving knowledge of the random salt value.

14. (canceled)

15. The method of claim 13, wherein the random salt value is a private key, and wherein the method comprises:
obtaining a third message;
generating a third signature based on at least the random salt value and the third message; and
making the third signature, the third message and a public key corresponding to the random salt value available to the verifying party for proving that the third signature is a valid signature for the third message when verified using the public key corresponding to the random salt value.

16. (canceled)

17. The method of claim 1, comprising:
generating a root hash of a hash tree, wherein each respective public key corresponding to the respective data item is hashed to generate a respective leaf hash of the hash tree; and
transmitting the root of the hash tree to one or more of the participants and/or a verifying party.

18. The method of claim 15, comprising transmitting a hash proof to the verifying party for verifying that the first public key corresponding to the first data item is an element of the hash tree.

19. The method of claim 1, wherein the first message comprises at least part of a blockchain transaction.

20-23. (canceled)

24. A computer-implemented method of verifying that a digital signature has been partly generated by a first participant, wherein the method is performed by a verifying party and comprises:
obtaining a first signature comprising first and second signature components;
obtaining a candidate first external data item from the first participant, and one or more respective public key corresponding to a respective data items, one for each other participant;
generating a candidate public key based on a hash of the candidate first external data item;
generating a candidate ephemeral public key based on the candidate public key and the obtained one or more public keys;
generating a candidate first signature component based on the candidate ephemeral public key; and
verifying that the first signature has been partly generated by the first participant based on whether the candidate first signature component corresponds to the first signature component.

25-37. (canceled)

38. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method of generating a share of a digital signature, wherein each participant of a group of participants has a respective share of a first shared private key, and wherein the method is performed by a first participant of the group and comprises:
obtaining a first message;
generating a first data item based on at least a hash of a first external data item;
generating a first ephemeral private key share of an ephemeral private key, wherein the first ephemeral private key share is generated based on the first data item and a respective data item generated by each other participant;
generating an ephemeral public key corresponding to the ephemeral private key;
generating a first signature share based on the first message, the first ephemeral private key share, a first share of the first shared private key, and the ephemeral public key; and
making the first signature share available to a coordinator for generating a first signature based on at least a threshold number of respective signature shares.

39. A computer program embodied on a non-transitory computer-readable storage and configured so as, when run on one or more processors, the one or more processors perform a method of generating a share of a digital signature, wherein each participant of a group of participants has a respective share of a first shared private key, and wherein the method is performed by a first participant of the group and comprises:
obtaining a first message;
generating a first data item based on at least a hash of a first external data item;
generating a first ephemeral private key share of an ephemeral private key, wherein the first ephemeral private key share is generated based on the first data item and a respective data item generated by each other participant;
generating an ephemeral public key corresponding to the ephemeral private key;
generating a first signature share based on the first message, the first ephemeral private key share, a first share of the first shared private key, and the ephemeral public key; and making the first signature share available to a coordinator for generating a first signature based on at least a threshold number of respective signature shares.
